(19) United States
(12) Patent Application Publication
(10) Pub. No.: US 2015/0088428 A1
(43) Pub. Date: Mar. 26, 2015

(54) COMPUTATIONALLY EFFICIENT NONLINEAR STRUCTURAL ANALYSIS

(71) Applicant: SAN DIEGO STATE UNIVERSITY RESEARCH FOUNDATION, San Diego, CA (US)

(72) Inventor: ROBERT DOWELL, San Diego, CA (US)

(73) Assignee: SAN DIEGO STATE UNIVERSITY RESEARCH FOUNDATION, San Diego, CA (US)

(21) Appl. No.: 14/034,521

(22) Filed: Sep. 23, 2013

(51) Int. Cl. G01V 1/30

(52) U.S. Cl. CPC G01V 1/30
USPC 702/14

(57) ABSTRACT

Seismic displacement demands for design of a bridge frame structure are typically determined from linear-elastic analysis (LEA), which are often incorrect, and compared to displacement capacity from a nonlinear pushover analysis. Nonlinear time-history analysis (NTHA) provides the most realistic assessment of displacement demands because it properly models the physics of the dynamic problem, wherein stiffness of the bridge varies over time. However, using NTHA to determine a bridge response from multiple earthquake motions based on the stiffness method requires excessive time. A unique approach for determining the nonlinear time-history response of a bridge frame is disclosed that is thousands of times faster than the stiffness method while providing the same results. Computational efficiency allows bridge design engineers to use NTHA for the seismic design of bridge structures by producing multiple determinations in less than one second. Displacement demands and capacities are based on nonlinear bridge behavior, resulting in safer bridge structures and reduced construction costs.

### CLAIM OF PRIORITY UNDER 35 U.S.C. §119

The present application for Patent claims priority to Provisional Application No. 61/705,140 entitled “Nonlinear Incremental Closed-Form Method for Frame Structures” filed Sep. 24, 2012, and assigned to the assignee hereof and hereby expressly incorporated by reference herein.

### BACKGROUND

1. Field

The present invention relates generally to seismic bridge design, and more specifically to computationally efficient nonlinear time-history analysis for determination of bridge frame response and demands.

2. Background

Nonlinear seismic time-history analysis for bridge frame structures is traditionally performed using an incremental stiffness method. For each small time increment (typically between 0.005 and 0.02 seconds), a change in ground acceleration is applied to the base of the bridge structure. Incremental member forces as well as displacements are determined by solving a system of simultaneous equations using matrix mathematics. The total response of the structure at any time during the earthquake is found by summing all prior incremental results.

This approach can require one or more hours for one earthquake analysis. A full measured earthquake record may contain accelerations at 10,000 time increments, and because of nonlinearities in the response, the complete bridge structure must be solved at each of these increments. Therefore, all of the simultaneous equations required for a single loading case are solved 10,000 times in a row, resulting in excruciatingly slow computation times. Additionally, due to the numerical nature of the stiffness method, iteration is often required to satisfy equilibrium when nonlinearities occur.

Computer nonlinear structural analysis algorithms based on the stiffness method frequently malfunction while performing iterations associated with severe nonlinearities and, because subsequent results are a summation of all prior results, produce no results for the remainder of the earthquake record. Because these severe nonlinearities occur at maximum earthquake shaking, the traditional matrix approach usually provides accurate response results only from small earthquake shaking at the start of the earthquake. Due to the extremely slow computational speed and iteration failures, current nonlinear time-history analysis methods are not practical for commonplace bridge design. Especially since each earthquake analysis can take up to an hour or more, and multiple earthquakes analyses are required to allow for variability of future seismic events.

One skilled in the art would recognize that building structures are analyzed in much the same way as bridges. Ground motions are provided as accelerations to the base of the building at multiple time increments and the nonlinear response of the building is found using time-history analysis with the stiffness method to determine incremental results. Total results at any point during the earthquake are found from summing all prior incremental results. As with bridge frame structures discussed above, multiple simultaneous equations must be solved at each time increment. The same difficulties exist for analyzing building frame and other structures under severe seismic motion. There is, therefore, a need in the art for a highly time-efficient and cost-effective method for determining an exact solution for structural motion response using simple equations, which can provide a worldwide commonplace tool for bridge and other structural design.

### SUMMARY

Embodiments disclosed herein address the above stated needs by providing a method for generating an exact structural analysis under any conditions by disclosing a convergent geometric series and taking it to the limit with calculus to produce a high speed exact solution with simple closed-form equations. This method provides an exact solution without failing under nonlinear conditions by incrementally summing non-numerical results from individual closed form equations to provide a total result at all times.

A novel incremental closed-form method (ICFM) solves the incremental member forces through analytical equations and in this sense, at each time increment, this is not a numerical approach. It is this analytical solution that gives (1) the method its stability and (2) its computational speed, since no simultaneous equations are required as in the stiffness method. Total results are found by summing all of the incremental results up to a given time. While other known methods depend on matrix mathematics, the closed-form equations used in the ICFM require no matrices or vectors and yet provide exact results. The new ICFM can be viewed as a combination of analytical and numerical approaches to determine the nonlinear time-history response of a frame structure subjected to earthquake motions. Numerical analysis is used to advance the displacement, velocity and acceleration results of the structure for each time increment while the analytical (closed-form) equations are used to find the exact change in member forces that occurred over the same time increment.

### BRIEF DESCRIPTION OF THE DRAWINGS

FIG. 1 illustrates exemplary bridge frame structures for computationally efficient nonlinear structural analysis;

FIG. 2 illustrates exemplary incremental column fixed end-moments of a bridge structure for computationally efficient nonlinear structural analysis;

FIG. 3 illustrates exemplary final incremental column and superstructure end-moments of a bridge structure for computationally efficient nonlinear structural analysis;

FIG. 4 illustrates exemplary column nonlinear moment-rotation springs for computationally efficient nonlinear structural analysis;

FIG. 5 illustrates exemplary Time Shift and Increment Renumbering for computationally efficient nonlinear structural analysis;

FIG. 6A is an exemplary high level flow chart illustrating the computationally efficient Incremental Closed Form Method (ICFM) for nonlinear structural analysis;

FIG. 6B is an exemplary detailed flowchart illustrating the computationally efficient Incremental Closed Form Method (ICFM) for nonlinear structural analysis;

FIG. 7 illustrates a bridge frame superstructure in an exemplary nonlinear time-history analysis using a computationally efficient nonlinear structural analysis algorithm;

FIG. 8 details an exemplary bridge frame superstructure cross-section geometry in an exemplary nonlinear time-history analysis using a computationally efficient nonlinear structural analysis algorithm;

FIG. 9 details exemplary column plastic moments of a bridge frame superstructure in an exemplary nonlinear time-history analysis using a computationally efficient nonlinear structural analysis algorithm;

FIG. 10 details the exemplary bridge frame measured ground acceleration time-history at one station of the 1989 Loma Prieta earthquake;

FIG. 11 details the exemplary bridge frame ground displacement time-history at one station of the 1989 Loma Prieta earthquake;

FIG. 12 details the exemplary bridge frame acceleration response spectrum at one station of the 1989 Loma Prieta earthquake;

FIG. 13 details the exemplary bridge frame computationally efficient structural analysis algorithm linear-elastic force-displacement results from the 1989 Loma Prieta earthquake;

FIG. 14 details the exemplary bridge frame computationally efficient structural analysis algorithm nonlinear force-displacement results from the 1989 Loma Prieta earthquake;

FIG. 15 details the exemplary bridge frame computationally efficient structural analysis algorithm linear-elastic displacement time-history response results from the 1989 Loma Prieta earthquake;

FIG. 16 details the exemplary bridge frame computationally efficient structural analysis algorithm nonlinear displacement time-history response results from the 1989 Loma Prieta earthquake;

FIG. 17 details the exemplary bridge frame computationally efficient structural analysis algorithm linear-elastic force time-history results from the 1989 Loma Prieta earthquake;

FIG. 18 details the exemplary bridge frame computationally efficient structural analysis algorithm nonlinear force time-history response results from the 1989 Loma Prieta earthquake;

FIG. 19 details the exemplary bridge frame computationally efficient structural analysis algorithm nonlinear displacement response results (between 5 and 15 s zoom-in) from the 1989 Loma Prieta earthquake;

FIG. 20 details the exemplary bridge frame computationally efficient structural analysis algorithm nonlinear force response results (between 5 and 15 s zoom-in) from the 1989 Loma Prieta earthquake.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The disclosed incremental closed-form approach to structural analysis is fundamentally different from previously known stiffness and moment distribution methods, wherein no simultaneous equations are required as in the stiffness method and moments need not be distributed back-and-forth as in moment distribution. At each time increment an exact incremental bridge or other structural response is found from simple closed-form equations. This novel method is exponentially faster than the incremental stiffness method, allowing a complete nonlinear earthquake analysis to be generated in a fraction of a second rather than up to an hour or more. Two example bridge analyses with different ground motions have shown the new method to be over 3,000 and over 5,000 times faster than the stiffness method. Advantageously, the present approach is stable under nonlinear conditions because results are determined from closed-from (analytical) equations without requiring matrix manipulations and without iterations. At each time increment, an algorithm monitors, for example, all column ends of a bridge for nonlinear behavior, as bridge frames are designed to allow nonlinear member behavior only at the column ends. If a nonlinear event occurs (i.e. plastic hinge) within the time increment, the algorithm determines the time it occurred and backs all results to this point, and changes the stiffness of the moment-rotation hinge at the column end, which results in a change to the frame stiffness. A new point is provided at each nonlinear event. There is no iteration needed to provide the correct results at the nonlinear event. Furthermore, there is no force overshoot before or after the event.

The algorithm also monitors the structure for unloading behavior. For example, when a bridge frame changes direction, the stiffness values of the plastic hinges and structure also change, affecting the response. If a direction change occurs within a time increment, the algorithm determines when this happened and returns all results to this time, providing an additional data point. The stiffness is changes and the solution scheme continues. Thus, no iteration is required.

Because the incremental closed-form approach is highly time-efficient and completely stable, ensuring that results are found for the full duration of the seismic event, multiple earthquake motions (for example 10 different average earthquake records) can be analyzed for a given bridge or other structure in approximately one to three seconds (fraction of a second per earthquake analysis). This novel method provides for nonlinear time-history analysis for cost-effective and time-efficient structural design, replacing current linear-elastic analysis methods, which cannot capture physical behavior under severe earthquake loading. It is important to note that different design codes (specifications) that govern the analysis and design of bridges and buildings do allow for more sophisticated nonlinear time-history analysis, but because they are highly inefficient and time-consuming, nonlinear time-history analysis is unfeasible for commonplace applications, which is very unfortunate as bridges and buildings are designed to respond to moderate and large earthquakes in the nonlinear range. Providing this new analysis tool allows structural design engineers to correctly assess the seismic behavior of various structures, making them safer and often less costly to construct.

The present invention resolves the three primary reasons that nonlinear time-history analysis (NTHA) is not performed for everyday bridge design in high seismic regions, namely, (1) that the analysis takes too long, (2) it often stops running due to numerical difficulties at the time of largest shaking, providing no results at or beyond this point of most interest and (3) the future earthquake motion that the bridge will be subjected to is unknown. Traditionally, displacement demands are found from linear-elastic spectral analysis (LESA) and compared to displacement capacity determined from a nonlinear pushover analysis. This approach is loosely based on the equal displacement principle, which states that linear-elastic and nonlinear seismic displacement demands are approximately equal, so long as the initial stiffness for nonlinear analysis is the same as the linear-elastic stiffness. While maximum displacements may be similar between LESA and NTHA, force demands from linear-elastic analysis are typically many times larger than from nonlinear analysis due to column-end plastic hinges that limit the force levels. It is widely accepted that NTHA is far superior to LESA and linear-elastic time-history analysis (LETHA), as it recognizes the proper physics of the problem, with changing stiffness as plastic hinges form and cycle at the ends of the columns, which they are designed and detailed to do.

The present algorithm comprises closed-form equations used to determine incremental forces of a redundant bridge frame that develop from each time step of the earthquake record. In this sense, the incremental closed-form method (ICFM) is not numerically-based but analytical, at least at each time step, resulting in exact force values and a stable analysis. Total results at all times are found by summing the prior incremental results. No simultaneous equations are required, resulting in the extremely fast analysis presented here. Nonlinear behavior can only occur at the columns ends, which is consistent with bridge design practice. All other structural members are protected from going nonlinear by capacity-design principles. Any number of spans can be analyzed (from one to infinity).

As mentioned above, one often-cited reason for not using NTHA for seismic bridge design is that the future earthquake motion is not yet known. Therefore, many different earthquake motion analyses would need to be conducted in order to reveal all possible structural responses. Because a single NTHA calculation requires excessive time using the traditional stiffness method, consideration of multiple analyses becomes daunting for commonplace design purposes. Due to the sheer speed and computational efficiency of the novel approach presented here (ICFM), many different earthquake motions can be considered and maximum (or average) responses automatically collected and presented. Calculating 10, 100 or even 1,000 NTHAs to support a new bridge design using the proposed ICFM presents no difficulty, essentially placing the power of a supercomputer on each user's desk.

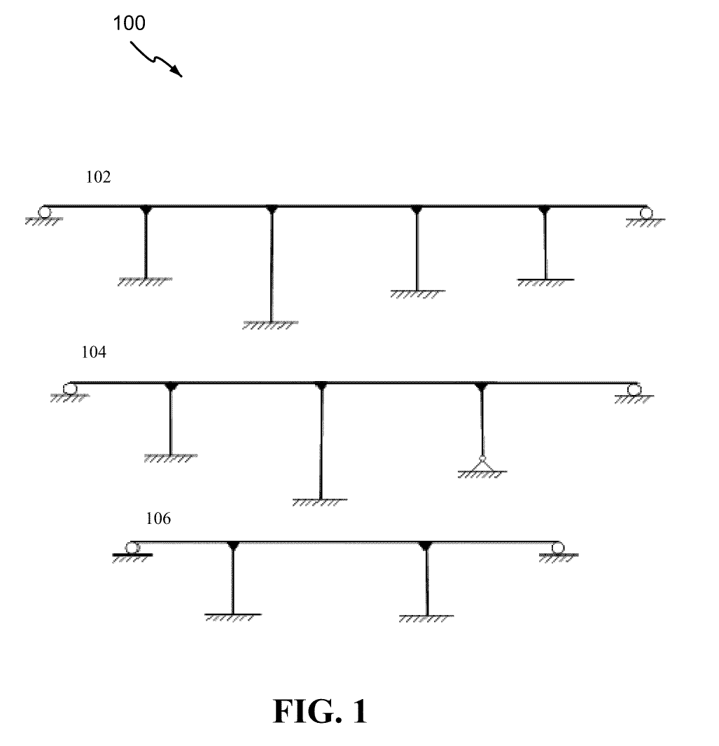

FIG. 1 illustrates exemplary bridge frame structures 100 for computationally efficient nonlinear structural analysis wherein bridge 102 comprises five spans, bridge 104 comprises four spans and bridge 106 comprises 3 spans. Computationally efficient nonlinear structural analysis is advantageously applied to any number of bridge spans. A bridge structure is used herein and throughout while one skilled in the art would understand that computationally efficient nonlinear structural analysis can be applied to any type of frame structure. The extremely fast and stable seismic analysis of a bridge frame is realized in computationally efficient nonlinear structural analysis by combining (1) incremental closed-form equations, (2) event-scaling analysis, (3) capacity design principles and (4) the average acceleration method. The computationally efficient nonlinear structural analysis algorithm incorporates approaches (1)-(4) to determine the response over time of a bridge frame that can develop plastic hinges at its column ends.

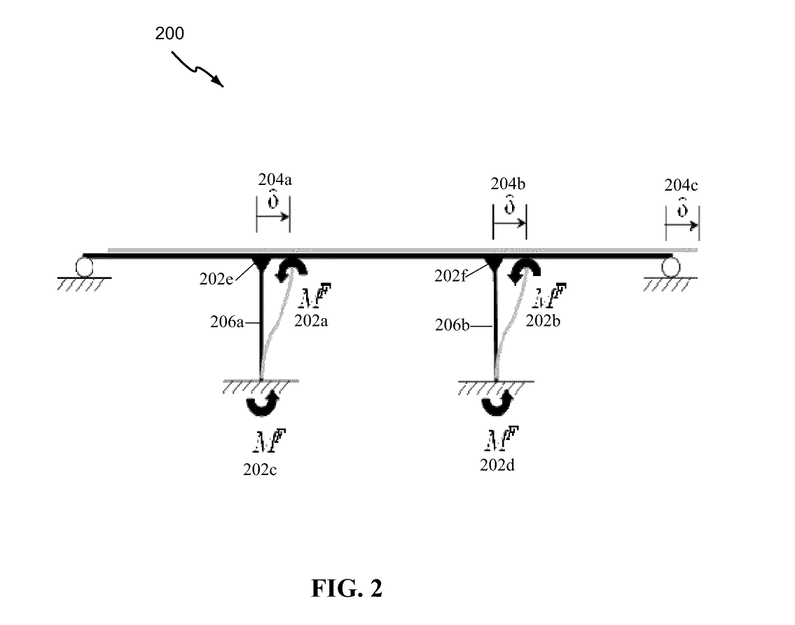

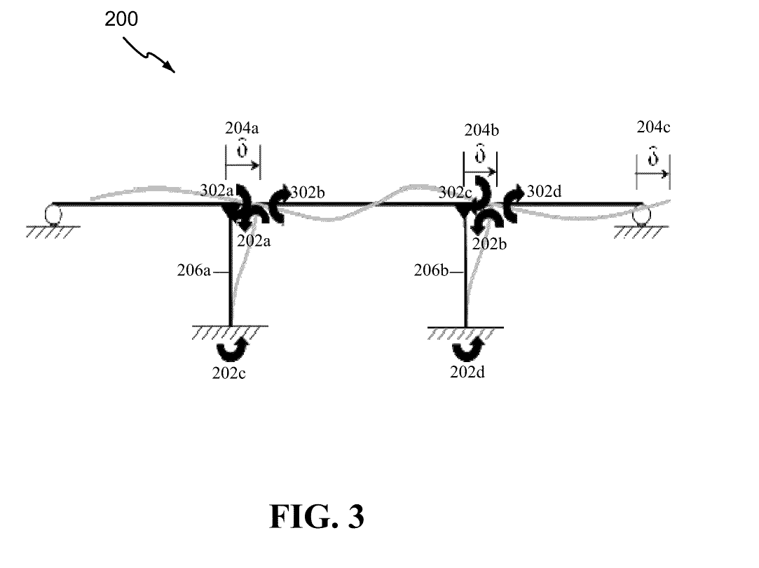

FIG. 2 illustrates exemplary bridge frame structure 200, column fixed-end-moments 202a-d for computationally efficient nonlinear structural analysis. The computationally efficient nonlinear structural analysis ICFM algorithm gives a displacement increment 204a-c to the bridge frame structure 200 while the joints are fixed from rotation, resulting in incremental fixed-end-moments at the column ends 202a-d and incremental out-of-balance moments 202a-b at the internal joints 202e-f. The algorithm's closed-form equations are then used to determine final incremental member-end-moments 202a-d (in FIG. 3) and 302a-d (in FIG. 3) associated with this displacement increment 204a-c of the frame structure 200. Note that 202a-d in FIG. 3 have different values than 202a-d in FIG. 2. In FIG. 2 they are the column fixed-end-moments (internal joints fixed from rotation) and in FIG. 3 they are the final moments after the internal joints have been allowed to rotate to find equilibrium. Each change in displacement 204a-c is found from an equation of motion, using the stable average acceleration method. Each displacement increment is based on the current stiffness of the frame 200, including flexibility of the superstructure and columns. The closed-form equations were derived directly from the logic of moment distribution and calculus.

FIG. 3 illustrates exemplary final incremental column and superstructure end-moments of a bridge structure for computationally efficient nonlinear structural analysis. Moments are found from the incremental closed-form equations while holding the frame 200 at the same incremental sway displacement level 204a-c that developed the fixed-end-moments shown in FIG. 2, resulting in final incremental moments at the superstructure and column ends 202a-d and 302a-d. Once the member-end-moments are known, all other member forces (shear forces/axial forces) and reactions are readily found from statics.

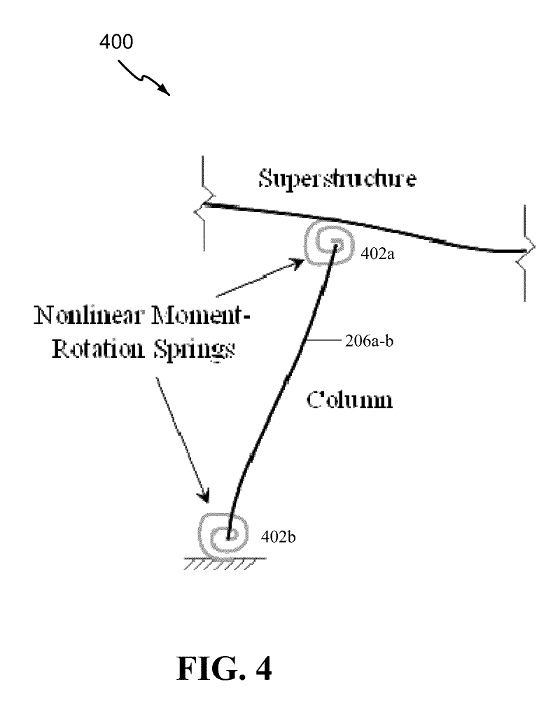

FIG. 4 illustrates exemplary column nonlinear moment-rotation springs 400. Columns 206a-b are modeled as beam members with nonlinear moment-rotation springs at both ends 402a-b such that elasto-plastic behavior, or the more complex behavior defined by the Takeda or Pivot Hystgersis models, can readily be analyzed by the computationally efficient nonlinear structural analysis algorithm.

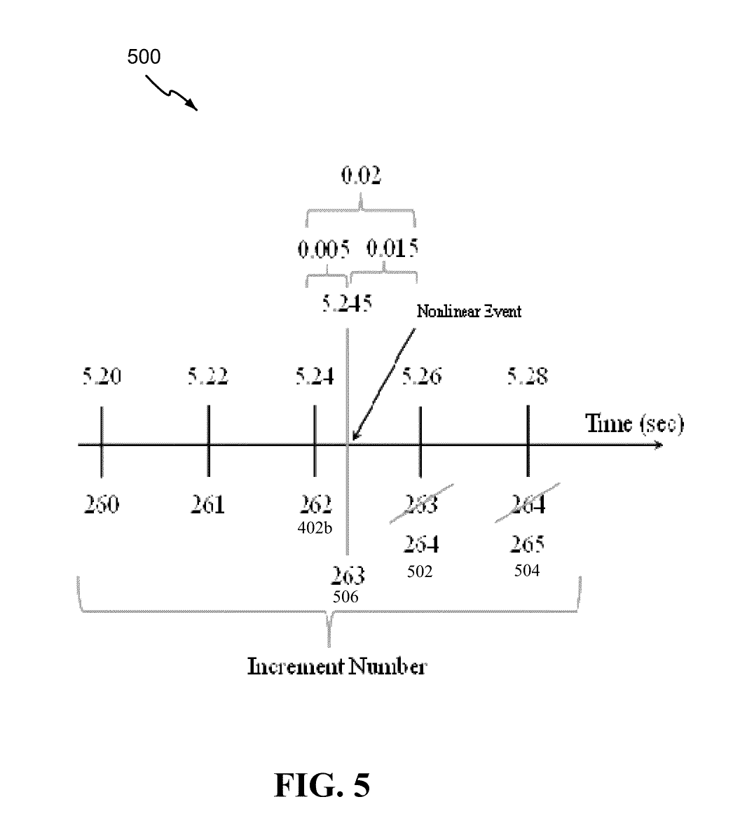

FIG. 5 illustrates exemplary Time Shift and Increment Renumbering for computationally efficient nonlinear structural analysis 500. The speed and stability of the computer computationally efficient nonlinear structural analysis algorithm result from the use of (1) the closed-form equations at each time increment to determine the change in member-end-moments, with no simultaneous equations or numerical analyses required, and (2) event-scaling when a column moment has exceeded the plastic moment capacity of one of the column ends. All moments and time values are scaled back to the exact values when the event developed, with no iteration necessary and no force overshoot. For each time increment the response of the structure is linear, and to allow for nonlinear behavior the results are scaled back to the exact point when a nonlinear event has occurred. The stiffness of the system is changed (recognizing nonlinear behavior) and then the structure response is found for the next time increment, also as a linear response. In FIG. 5, the increment times are initially 0.02 s, but between increment numbers 262 and 263 a nonlinear event develops. Using the equations from the average acceleration method, a simple and exact solution for the time when this event occurred was derived. In this example, the nonlinear event occurs 0.005 s into the full time step of 0.02 s. A new increment step is provided at the time of the nonlinear event, and all future increments are relabeled (this is indicated by the diagonal line across increment numbers 263 and 264 and new labels 263 through 265). Forces are linearly scaled back to the time of the event, resulting in one column moment that exactly equals its plastic moment capacity and all other column moments that are below their capacities. An additional data point 506 is provided at the time the event occurred, requiring a reduced time step to that point and another reduced time step to the end of the original full time step. In the example provided in FIG. 5, the nonlinear event happened between steps 262 and 263 (502) at 5.245 s, with the full time step of 0.02 s reduced to 0.005 s. A new point is provided at the time of the event, with this now defined as step 263 (506), requiring all further steps to be renumbered. After the reduced time step of 0.005 s to reach the event, a second reduced time step of 0.015 s is used to make up a full time step of 0.02 s and get to the new step 264 (502) at time 5.26 s. Until another event occurs, the analysis continues from step-to-step with full time steps of 0.02 s. If additional events develop within one full time step, the same process is followed.

Often more than one plastic hinge occurs at the same time (within a given tolerance). In this case, the computationally efficient nonlinear structural analysis algorithm allows multiple nonlinear hinges to develop as one event. Ground accelerations must also be scaled (interpolated) to agree with the modified time steps. The stiffness is changed following scale-back to reflect the new frame condition of a pin holding a plastic moment with no rotational stiffness (no additional moment capacity while the hinge is free to rotate) at the plastic hinge location. When a displacement reversal occurs, the time of reversal is found (also based on an exact equation derived from the average acceleration method) and the event-scaling procedure is employed so that the correct stiffness is included for the reduced time step following reversal. If a reversal happens when there is no nonlinear behavior then there is no scale-back required, as the stiffness will not change.

Bridges are designed to force nonlinear behavior into the column ends while protecting the superstructure and footings from inelastic behavior. This is achieved by providing more strength to these members than can be induced by column plastic hinges based on capacity design principles. Column end regions are specially designed and detailed to allow large plastic rotations, which translate to large displacement capacity of the bridge frame. Prior to seismic analysis, the closed-form equations are used to determine superstructure and column-end-moments from the self-weight of the bridge. Potential gravity sidesway is included in determination of dead load moments. The structural analysis algorithm calculates no-sway dead load moments from the closed-form equations. A second application of the closed-form equations from a scaled lateral sway provides the dead load sway moments, with total dead load moments equal to the sum of the no-sway and sway values. Dead load results are verified by checking that the column base shears for the entire frame sum to zero. This is the condition the bridge frame will be in at the time of an earthquake, and so the existing dead load column moments must be included in the seismic analysis as they affect how much additional moment is required to cause plastic hinging. The new computationally efficient nonlinear structural analysis algorithm based on the ICFM automatically considers this.

The explicit form of the average acceleration method (a Newmark-Beta method) was used to advance the solution to the next time increment of the earthquake. In one exemplary embodiment, this specific Newmark-Beta method is used because it is unconditionally stable and because it requires no iteration to move from step-to-step. At the start of an earthquake, the initial stiffness of the bridge frame is used in the equations of motion. This stiffness will change only following an event, including the formation or unloading of a plastic hinge. When an event has occurred, all of the results are scaled back to the time when the event first happened, without iteration. The stiffness of the frame is changed and the equations from the average acceleration method are used to move to the next time increment.

Following a nonlinear event, and before scaling results back to the time of this event, the moment-rotation stiffness of the plastic hinge is changed in the computationally efficient nonlinear structural analysis algorithm and one additional full time step is taken to determine the reduced lateral stiffness of the bridge frame. The sum of the base shears represents the change in restoring force of the frame and the new stiffness is this force divided by the incremental displacement. Until another nonlinear event occurs, this is the stiffness that is used in the various equations of the explicit form of the average acceleration method.

At the end of each time increment, the average acceleration method provides incremental displacement, velocity and acceleration values of the bridge frame, which are added to the prior results to obtain total values up to that point in time, ultimately giving complete time-history responses for the earthquake. Incremental column moments are added to the prior values to obtain total column moments at the end of the time increment. This process continues until a column moment exceeds the plastic moment capacity of one of the column ends, where the moments are largest. Column and superstructure moments, as well as the frame displacement, are scaled back to their values at the time of the nonlinear event.

The stiffness of the frame changes following each nonlinear event, representing the plastic hinge that has occurred, and a new incremental response is found, continuing until all time increments for the base motion have completed. If the relative frame displacement reverses, the time when this reversal happens is calculated, without iteration, and all relevant results are scaled back to the appropriate values. Upon frame displacement reversal, all plastic hinges start unloading, returning to their rigid state, and the original frame stiffness is used until another plastic hinge has formed. Multi-degree-of-freedom nonlinear seismic analysis is conducted (multiple displacement DOF, including joint rotations and frame translation) using the ICFM for a bridge frame with a single mass degree-of-freedom representing the mass of the entire frame. Once the complete closed-form method is finalized, which will include member axial deformations, then multiple mass degrees-of-freedom are also possible.

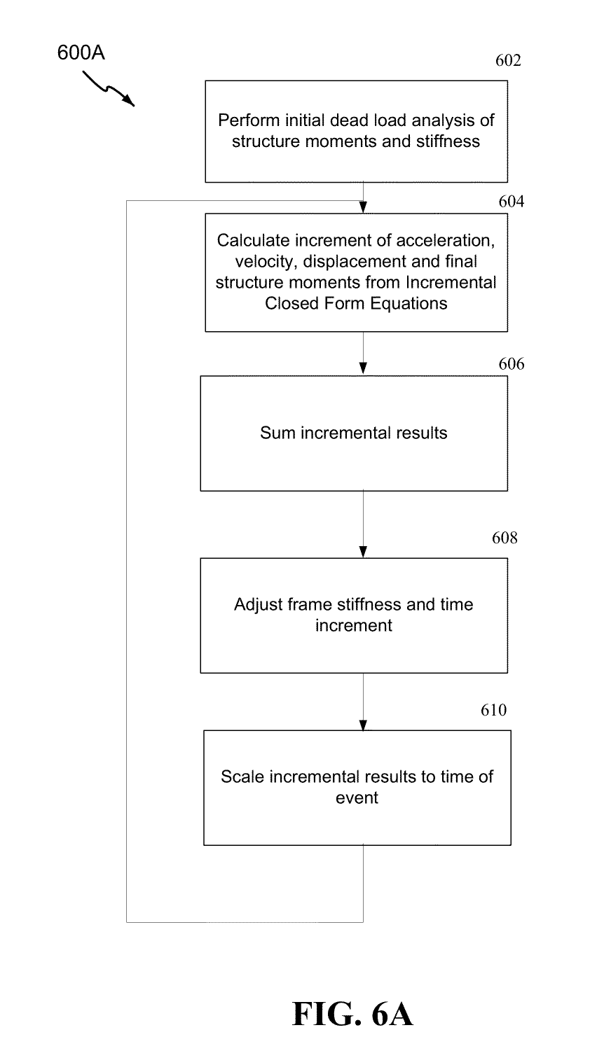

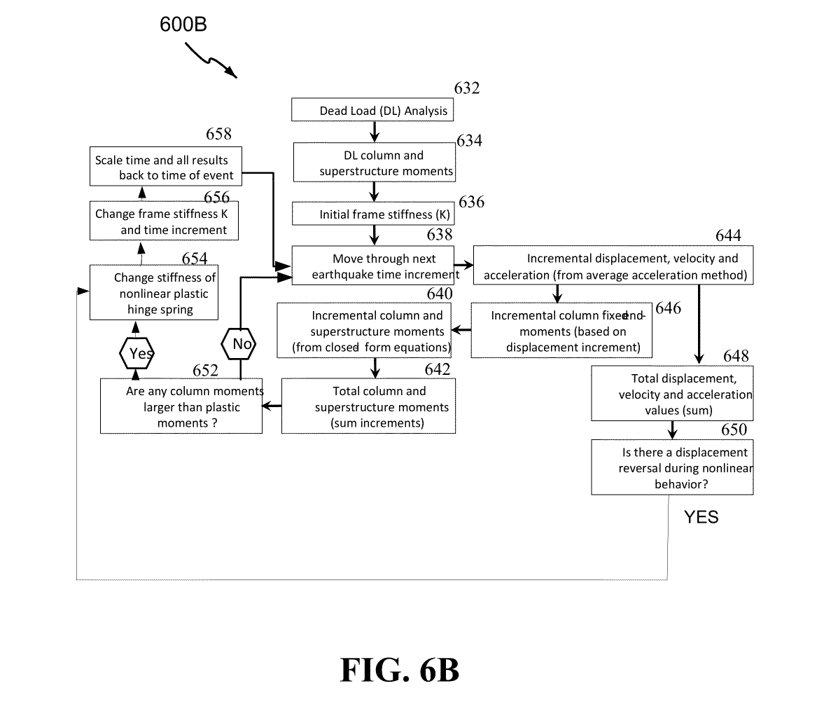

FIG. 6A is an exemplary high level flow chart illustrating the computationally efficient Incremental Closed Form Method (ICFM) for nonlinear structural analysis 600A where frame structure forces are analytically (non-numerically) determined using present novel ICFM equations for each time increment of the analysis and then numerically summing the incremental moment values to produce a total sum value structural analysis.

Processing begins in step 602, where an initial dead load analysis of structure moments is performed and initial lateral stiffness determined Control flow proceeds to step 604.

In step 604, an increment of acceleration, velocity, displacement and final structure moments are calculated from the ICFM Equations. Control flow proceeds to step 606.

In step 606, the increment values calculated in step 604 are summed to produce a total sum value of all calculated time increment values. Control flow proceeds to step 608.

In step 608, frame stiffness values are adjusted for a next increment calculation. Control flow proceeds to step 610 where the results for each increment are scaled to the time of an event. Processing continues as detailed above until ICFM calculations of all time increments of the ground motion have been completed and summed Steps 602-610 are further detailed in FIG. 6B

The ICFM equations given below are for an exemplary bridge frame structure having C number of internal joints, and provide final member-end-moments for the span just to the right (for right equations) or left (for left equations) of an exemplary Joint A, from a unit moment applied to exemplary Joint B. They also give final column member-end-moments. In addition to the general right and left equations, simplified equations are provided for the last and first internal joints, but are not required as they give the same results as the general equations. Thus, there are a total of four independent ICFM equations if left and right expressions are considerate separately. However, because the left and right expressions are symmetric (left equations can be derived directly from symmetry of the right equations), only two unique closed-form equations may be implemented, one for the superstructure and the other for the columns.

### Right Moments

A Superstructure Right Moment is defined as

$${AB}_{C} = \frac{{r}_{B} . {r}_{A}}{{( - 2 )}^{A - B} {R}_{B} \cdot {R}_{C}} {T}_{C} \cdot {T}_{A + 1} [ 1 - \frac{{t}_{A + 1}}{4 {T}_{A + 1}} ] \qquad ( Equ . 1 )$$

A Column Right Moment is defined as

$${AB}_{C} = \frac{{r}_{B} . {r}_{A - 1} {C}_{A}}{{( - 2 )}^{A - B} {R}_{B} \cdot {R}_{C}} {T}_{C} \cdot {T}_{A + 1} \qquad ( Equ . 2 )$$

A Simplified Superstructure Right Moment for a Last Internal Joint is defined as

$${CB}_{C} = \frac{{r}_{B} . {r}_{C}}{{( - 2 )}^{C - B} {R}_{B} \cdot {R}_{C}} {T}_{C} \cdot {T}_{A + 1} \qquad ( Equ . 3 )$$

and

A Simplified Column Right moment for a Last Internal Joint is defined as

$${CB}_{C} = \frac{{r}_{B} . {r}_{C - 1} {c}_{c}}{{( - 2 )}^{C - B} {R}_{B} \cdot {R}_{C}} \qquad ( Equ . 4 )$$

### Left Moments

A Superstructure Left Moment is defined as

$${BA}_{C} = \frac{{t}_{A} . {t}_{B}}{{( - 2 )}^{A - B} {T}_{1} \cdot {T}_{A}} {R}_{1} \cdot {R}_{B - 1} [ 1 - \frac{{r}_{B - 1}}{4 {R}_{B - 1}} ] \qquad ( Equ . 5 )$$

A Column left Moment is defined as

$${BA}_{C} = \frac{{t}_{A} . {t}_{B + 1} {c}_{B}}{{( - 2 )}^{A - B} {T}_{1} \cdot {T}_{A}} {R}_{1} \cdot {R}_{B - 1} \qquad ( Equ . 6 )$$

A Simplified Superstructure Left Moment for a First Internal Joint is defined as

$$1 {A}_{C} = \frac{{t}_{1} . {t}_{A}}{{( - 2 )}^{A - 1} {T}_{1} \cdot {T}_{A}} \qquad ( Equ . 7 )$$

### And

A Simplified Column Left Moment For a First Internal Joint is defined as

$$1 {A}_{C} = \frac{{t}_{2} . {t}_{A} {c}_{1}}{{( - 2 )}^{A - 1} {T}_{1} \cdot {T}_{A}} \qquad ( Equ . 8 )$$

wherein:
R=Cycle factor going to the right of the beam
T=Cycle factor going to the left of the beam
r=Distribution factor for member on the right side of a joint
t=Distribution factor for member on the left side of a joint
c=Distribution factor for column at a joint
AB_{C}=Member moment just to the right of Joint A from a unit moment applied at Joint B for a continuous beam or bridge frame with C number of internal joints
BA_{C}=Member moment just to the left of Joint B from a unit moment applied at Joint A for a continuous beam or bridge frame with C number of internal joints
r_{A}·r_{B}=Multiplication of r_{A}, r_{A+1}, . . . through r_{B}
r₂·r₅=Multiplication of r₂, r₃, r₄ and r₅
R_{A}·R_{B}=Multiplication of R_{A}, R_{A+1}, . . . through R_{B}
t_{A}·t_{B}=Multiplication of t_{A}, t_{A+1}, . . . through t_{B}
T_{A}·T_{B}=Multiplication of T_{A}, T_{A+1}, . . . through T_{B}
Note: if B equals A then r_{A}·r_{B}=r_{A}, t_{A}·t_{B}=t_{A}, T_{A}·T_{B}=T_{A}, R_{A}·R_{B}=R_{A}

FIG. 6B is an exemplary detailed flowchart illustrating a method for the incremental closed-form Method (ICFM) computationally efficient nonlinear structural analysis 600B. The algorithm begins in step 632 where the closed-from equations are used to determine no-sway and sway dead load forces. Processing continues with step 634.

In step 634, the total column and superstructure moments are found from dead load by summing the no-sway and sway results. Processing continues with step 636.

In step 636, a lateral unit displacement is applied with internal joints fixed from rotation, developing fixed-end-moments. Then the closed-form equations are used to calculate final moments for the unit sway. The column base shears are found from these end moments and statics, and then summed to determine the total applied force associated with the unit lateral displacement. The initial frame stiffness is this force divided by the lateral displacement. Processing continues with step 638.

In step 638, the ground acceleration is applied for a given time increment. Processing continues with step 644.

In step 644, the stable average acceleration method is used to determine the change in displacement, velocity and acceleration of the frame over the time increment. Processing continues with steps 646 and steps 648. In step 648, total displacement, velocity and acceleration are summed before proceeding to step 650 to watch for frame reversal (only if in a nonlinear state at time of reversal). When the velocity goes through zero, the frame has reversed and the analysis control then continues with step 654 as all plastic hinges have a new rigid stiffness. The time of reversal is directly calculated without iteration.

In step 646, the changes to column fixed-end-moments are found based on the displacement increment from step 644. Processing continues with step 640.

In step 640, the final incremental column and superstructure moments are determined from application of the closed-form equations to the incremental fixed-end-moments found in step 646. Processing continues with step 642.

In step 642, total column and superstructure moments are found by summing all prior incremental values up to that point in time. Processing continues with step 652.

In step 652, the column moments from step 642 are compared to the moment capacities at the column ends (plastic moments of the columns). If all of the column moment demands are smaller than the column moment capacities, then there is no nonlinear behavior and the analysis continues by returning to step 638 in order to process a next increment. Otherwise, if one or more of the column plastic hinges develop (moment demand is greater than capacity in step 652), processing continues with step 654 defined below In step 654 the rotational stiffness of the plastic hinge (moment-rotation spring) is set to zero if a plastic hinge has formed or made rigid if a reversal has occurred. Processing continues with step 656.

In step 656, an additional full time increment step is taken so that the algorithm can determine the new stiffness of the frame with the moment-rotation stiffness of one (or more) hinges changed in step 654. The new time increment to the time of the nonlinear event (formation of a plastic hinge or reversal) is also determined in step 656. Processing continues with step 658.

Step 658 scales all results back to the time of the nonlinear event, including forces, frame displacement, frame velocity and frame acceleration, as well as ground accelerations and processing returns to step 638.

Processing continues as detailed above until ICFM calculations of all time increments of ground motion have been completed and summed.

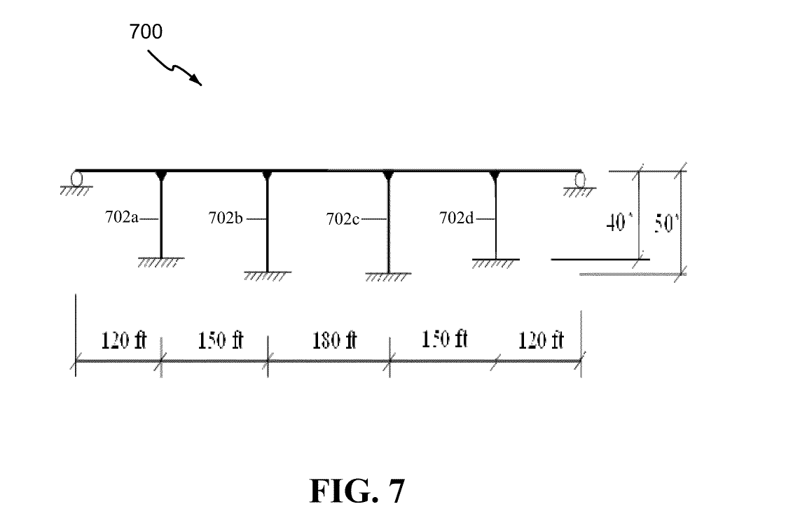

FIGS. 7-9 provide an exemplary nonlinear time-history analysis of a bridge frame using a computationally efficient nonlinear structural analysis algorithm.

FIG. 7 illustrates a bridge frame in an exemplary nonlinear time-history analysis using a computationally efficient nonlinear structural analysis algorithm. A 5-span, pre-stressed concrete bridge frame 700 has a total length of 720 ft. (219 m), with span lengths of 120 ft, 150 ft and 180 ft and column lengths (702a-d) of 40 ft. and 50 ft.

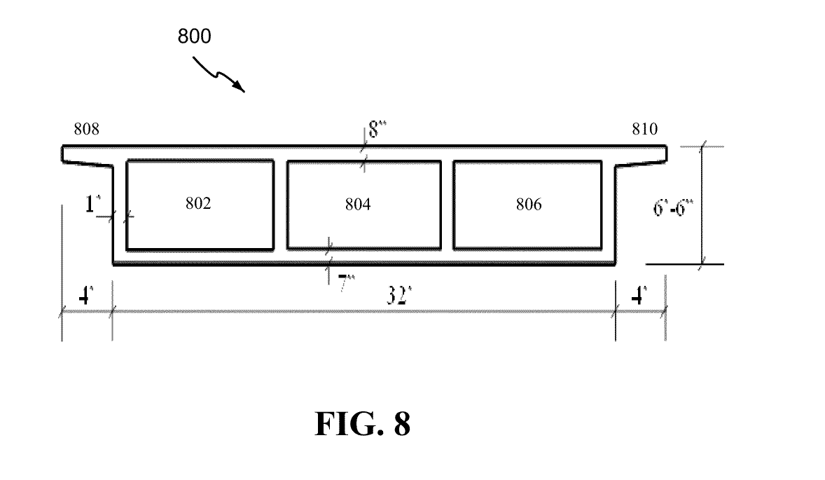

FIG. 8 details an exemplary bridge frame superstructure cross-section geometry in the exemplary nonlinear time-history analysis. The box-girder superstructure is 6 feet 6 inches (1.98 meters) deep, 40 ft (12.2 meters) wide 800, having three cells 802-806. Overhangs 808-810 are 4 ft (1.22 m) wide and vary in thickness from 8″ (0.203 m) at the edge-of-deck to 1 ft (0.305 m) at the girder face. Reinforced concrete columns are circular with 5′-6″ (1.68 m) diameter.

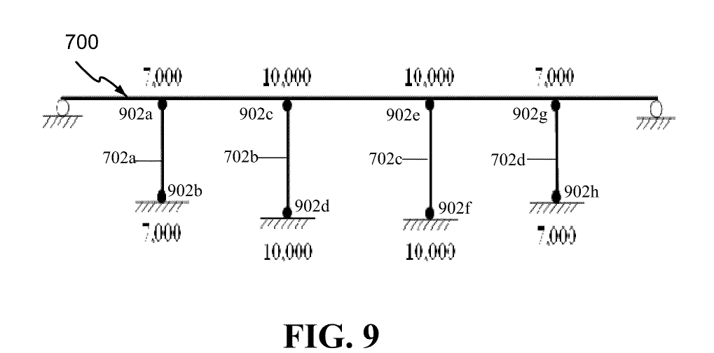

FIG. 9 details exemplary column plastic moments for the exemplary nonlinear time-history analysis of a bridge frame 700. Plastic moments 902a-h vary from column-to-column 702a-d due to different axial loads and primary steel percentages. The exemplary concrete is normal-weight (unit weight of 150 pcf (23.6 kN/m³)), with design strength of 4 ksi (27.6 MPa), and increased strength of 5 ksi (34.5 MPa) at the time of a future earthquake. Using the American Concrete Institute (ACI) equation for modulus of elasticity E, which is based on concrete strength, this value is found to be E=4031 ksi (1,230 MPa). Cracked properties are used for the columns, with cracked moment of inertia taken to be 50% of the gross section moment of inertia. For the pre-stressed bridge superstructure, 100% of the gross moment of inertia is used. Table 1 provides moment of inertia and cross-sectional area values for the columns and superstructure.

TABLE 1
Column and Superstructure Cross-Sectional Properties

| Bridge | I_{g} (ft⁴)/ | Area (ft²)/ | Iₑ (ft⁴)/ |
|---|---|---|---|
| Component | (m⁴) | (m²) | (m⁴) |
| Column | 44.92/0.388 | 23.76/2.21 | 22.46/0.194 |
| Superstructure | 439.0/3.79 | 67.67/6.29 | 439.0/3.79 |

Linear-elastic and nonlinear exemplary analyses were conducted using the proposed ICFM and the stiffness method to compare analysis results, as well as run times. The stiffness method is represented by the commercially available computer program SAP2000. For a fair comparison between the two methods, all input values, hysteresis models and assumptions are identical between the model used in SAP2000 and the model developed for the incremental closed-form approach. Axial and shear deformations are constrained in SAP2000, resulting in the same number of displacement degrees-of-freedom (seven displacement DOF; six rotations and one translation) and mass degrees-of-freedom (single translational mass DOF) as in the ICFM model. Also, the average acceleration method is used in both solution schemes, with 2% equivalent viscous damping. The fundamental natural period of the cracked bridge frame is Tₙ=1.23 s. The distributed superstructure self-weight is found by multiplying the unit concrete weight (150 pcf (23.6 kN/m³)) by its cross-sectional area, giving

wₛ=(0.150)(67.67)=10.15 kips/ft (148 kN/m) (Equ. 9)

In addition to the bridge self-weight, the superstructure carries two Type 25 barriers [13], one at the edge of each overhang, that weigh 0.392 kips/ft (5.72 kN/m) each. Thus, the total distributed weight along the bridge length is

w_{T}=10.93 kips/ft (159 kN/m) (Equ. 10)

Bent caps are regions of the superstructure, above the columns, that are solid and not cellular. For this bridge the width of the bent cap is 6 ft (1.83 m), slightly larger than the column size. The weight per bent cap, beyond the hollow superstructure weight already accounted for, is W_{BC}=132.3 kips (588 kN). Column distributed weight is w_{c}=3.564 kips/ft (52.0 kN/m), found from the unit concrete weight and column cross-sectional area. For inertial purposes in the dynamic analysis, it is assumed that half of the column mass goes to ground and the other half is included with the superstructure mass. Therefore, the total weight to be considered when calculating the mass is

W_{B}=(10.93)(720)+(132.3)(4)+(3.564)(40+50+50+40)/2=8720 kips (38,800 kN) (Equ. 11)

Allowing the mass of the bridge to be determined as

M_{B}=8720/32.2=270.8 kip*s²/ft (3,950 kg) (Equ. 12)

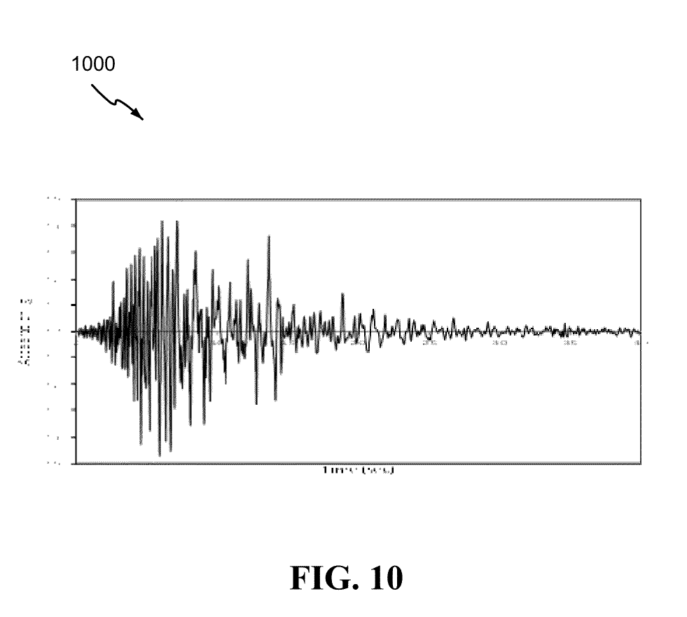

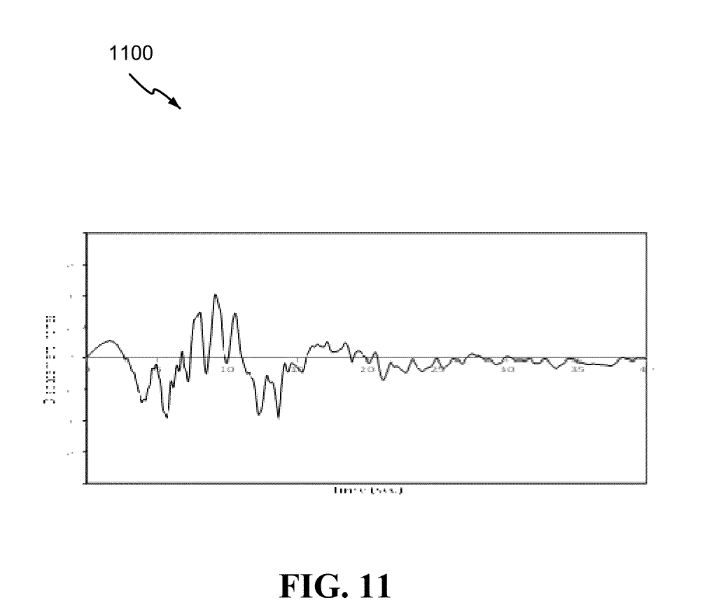

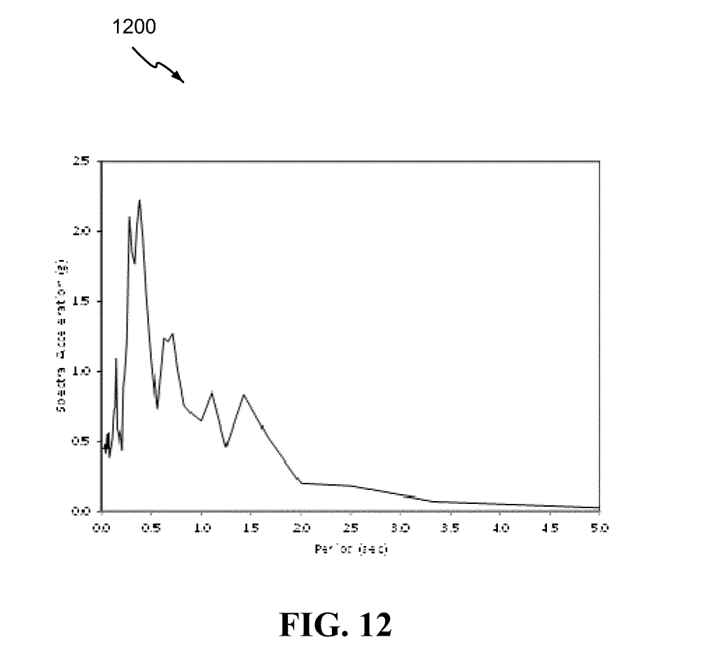

FIGS. 10-20 detail the results of subjecting the exemplary bridge frame superstructure 700 provided in FIGS. 7-9 to a recorded earthquake motion from the 1989 Loma Prieta earthquake using the computationally efficient nonlinear structural analysis algorithm. FIGS. 10-12 show the measured ground behavior, with the measured acceleration time-history (FIG. 10) used as input for the analysis. It was measured at the Capitola Fire Station in the East/West direction. Acceleration and displacement profiles are given in FIGS. 10 (1000) and 11 (1000), respectively. Peak ground acceleration is just below 0.5 g. A 5%-damped, linear-elastic acceleration response spectrum is provided in FIG. 12 (1200). The measured ground motion has duration of 40 s with time increments of 0.02 s, resulting in 2,000 increments.

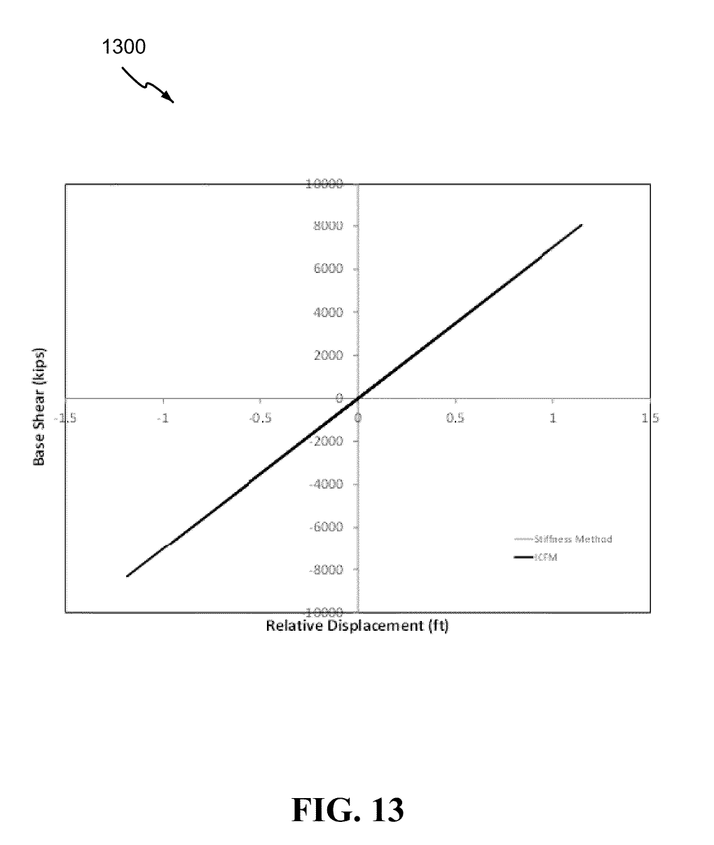

FIGS. 13-20 detail results from the analysis of the present computationally efficient nonlinear structural analysis algorithm applied to the exemplary structure.

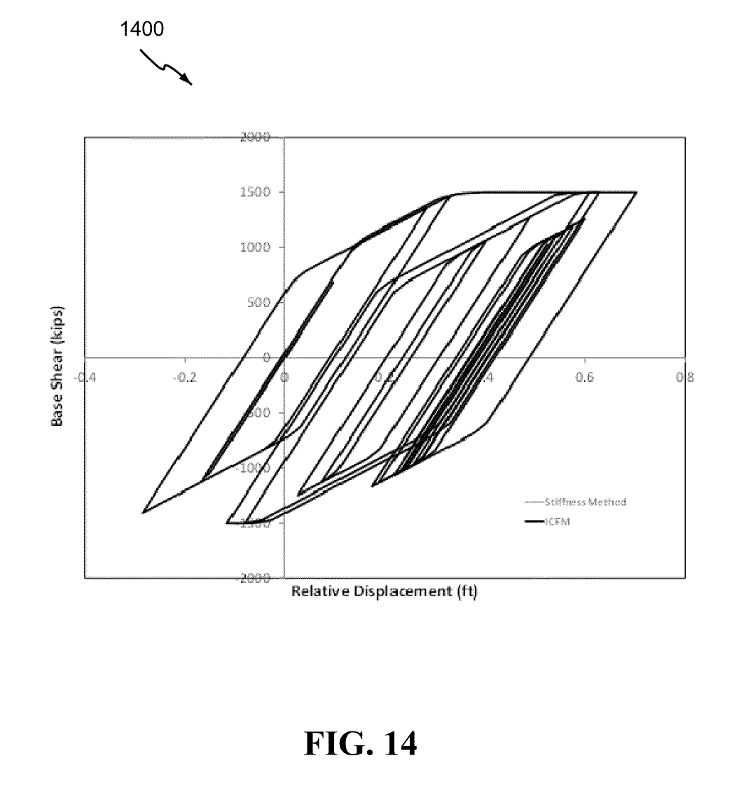

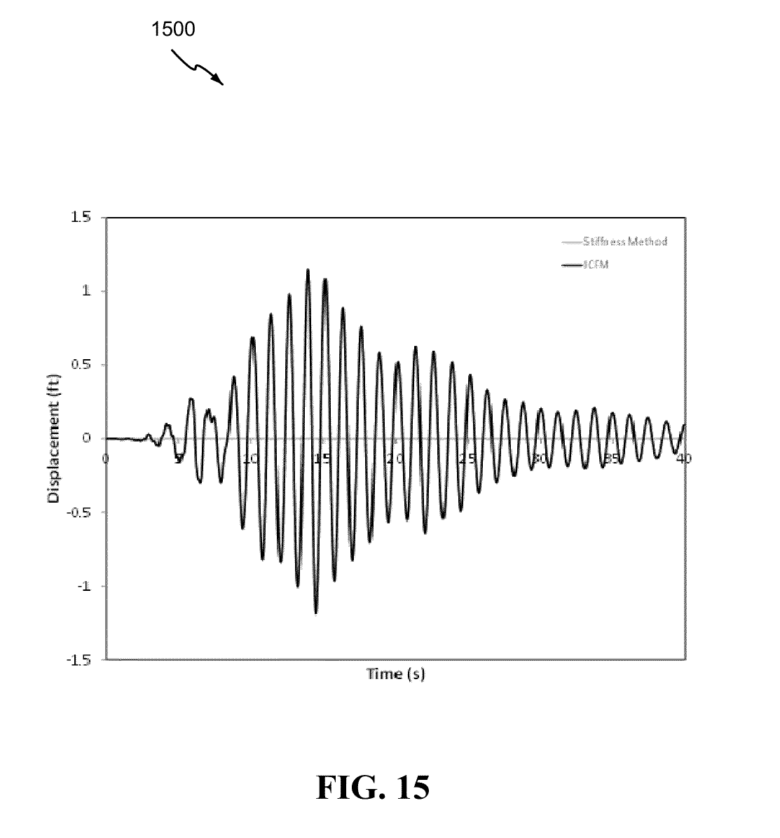

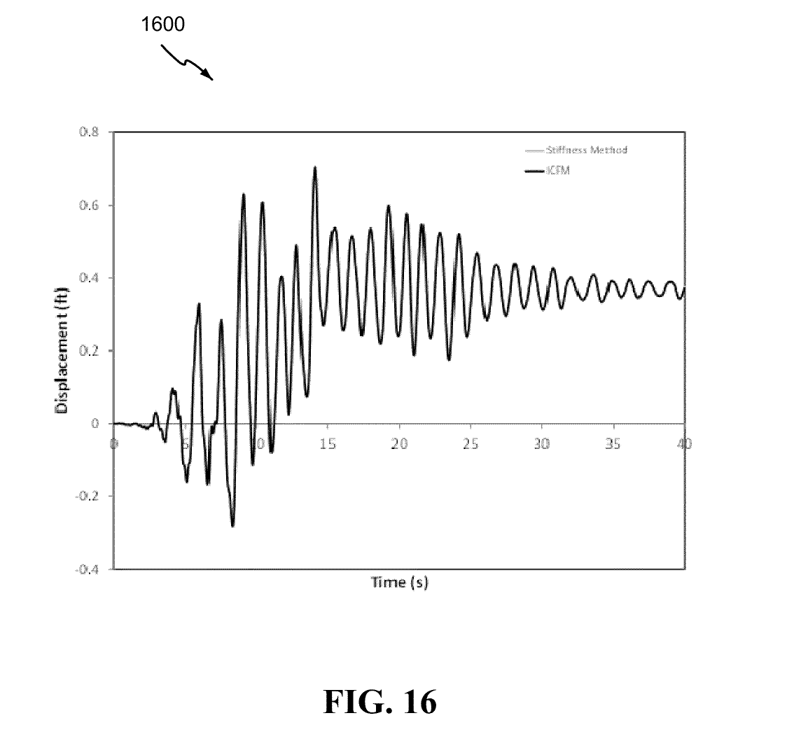

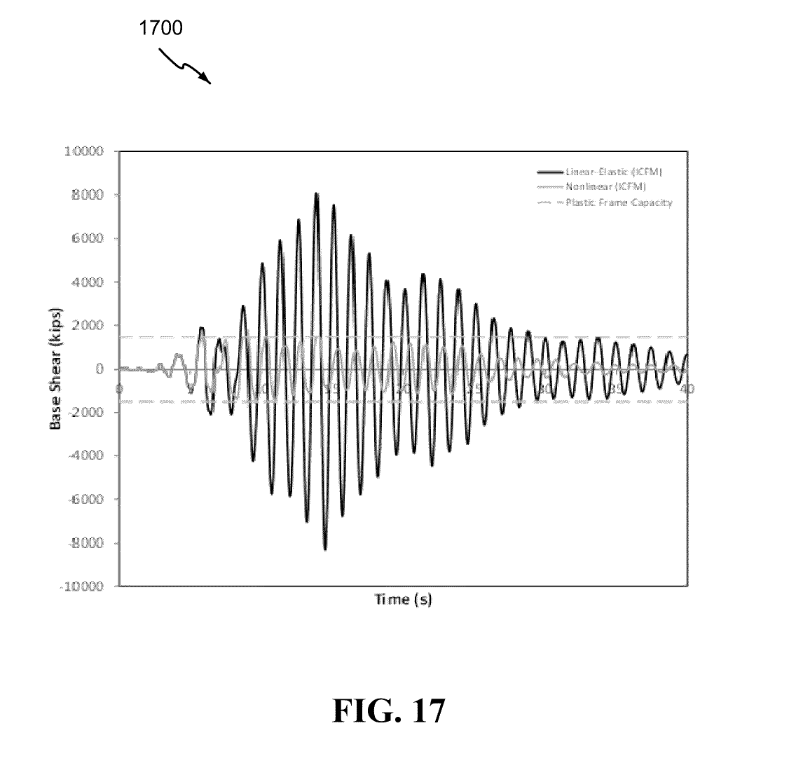

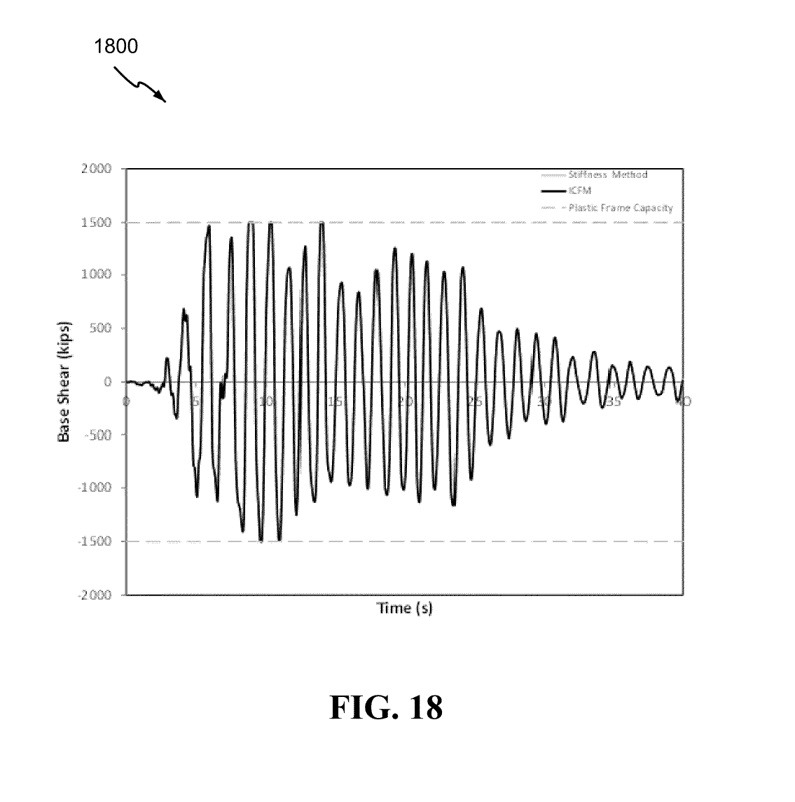

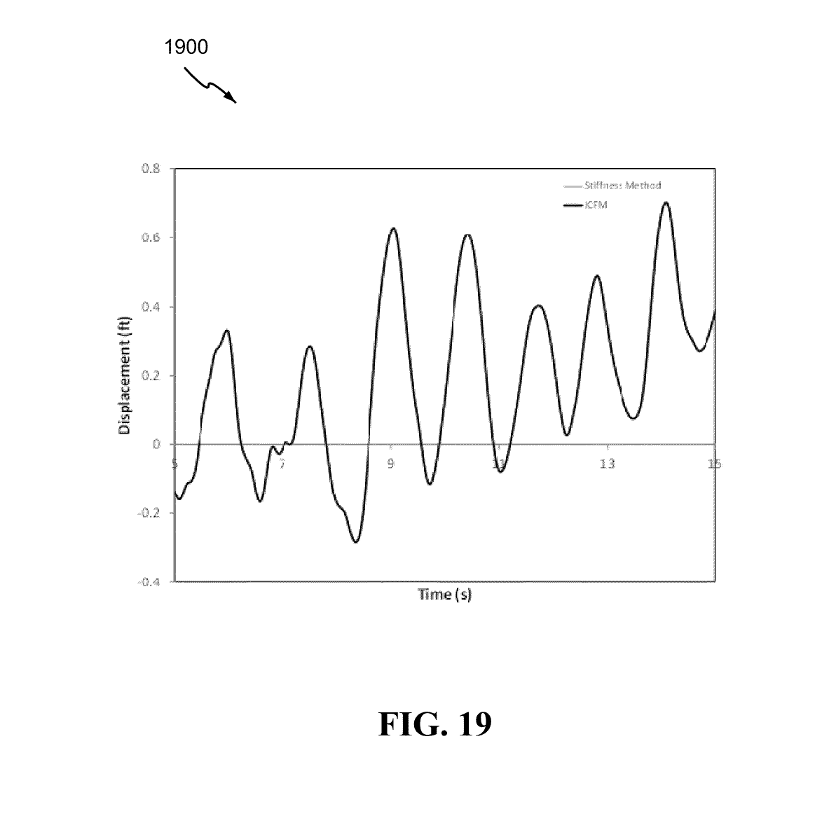

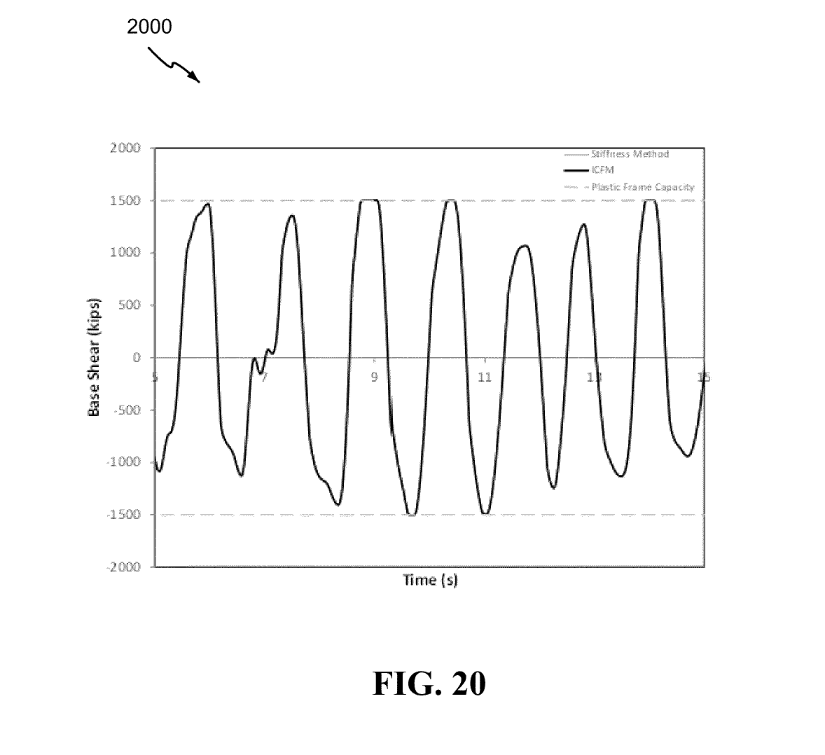

FIGS. 13 and 14 show the linear-elastic (FIG. 13) and nonlinear (FIG. 14) responses of the bridge frame, with total force on the y axis and relative frame displacement on the x axis. Relative displacement is the difference between the absolute displacements of the ground and the frame. The force is the sum of the column shears transferred to the ground (base shear). All of the figures show that the two methods (ICFM and stiffness method) provide the same results. FIGS. 15 and 16 give linear-elastic and nonlinear relative displacement results over time, with the x axis being time and the y axis relative displacement. FIGS. 17 and 18 provide linear-elastic and nonlinear results for frame base shear (y axis) versus time (x axis). Nonlinear results are also shown in FIG. 17 to demonstrate how much larger the linear-elastic force results are. In FIG. 18 the total force capacity of the frame is given as dotted lines (at plus and minus 1500 kips), with all plastic hinges developed. This shows that the nonlinear analysis scheme does not exceed the strength of the frame. Zoom-in results (between 5 and 15 s) for nonlinear displacements and forces are given in FIGS. 19 and 20, again demonstrating that the results from the new ICFM are the same as from the stiffness method.

The total nonlinear run-time for the exemplary bridge frame and ground motion using the stiffness method was 204.8 s compared to 0.0624 s from the present incremental closed-form approach. A ratio of these analysis times shows that for the exemplary case, the computationally efficient nonlinear structural analysis algorithm is more than 3,000 times faster than the stiffness method represented in SAP2000 as shown in Table 2.

TABLE 2
Nonlinear Time-History Solution Times for ICFM and Stiffness Method

| | | | | Stiffness | Closed- | |
|---|---|---|---|---|---|---|
| | | Time | | Method | Form | Ratio |
| | Duration | Increment | Number of | Solution | Solution | of |
| Earthquake File | (s) | (s) | Increments | Time | Time | Times |
| 1989 Loma | 40 | 0.02 | 2,000 | 204.8 s | 0.06240 s | 3,282 |
| Prieta EQ, | | | | (3.41 min) | | |
| Capitola Fire | | | | | | |
| Station E/W | | | | | | |
| Ch3 | | | | | | |
| 2010 Mexicali | 50 | 0.005 | 10,000 | 1,410 s | 0.2808 s | 5,021 |
| EQ, Calexico - | | | | (23.5 min) | | |
| El Centro | | | | | | |
| Array 11 N/S | | | | | | |
| Ch1 | | | | | | |

Because there were 2,000 increments in the ground motion, this dramatic increase in speed indicates that the ICFM would be finished with the full earthquake duration before a single time increment is assessed by the traditional stiffness method. Results are given in FIGS. 13-20 for both the present ICFM and the traditional stiffness method, as discussed previously. Because the values are almost identical, the graphs are nearly indistinguishable from one another. Linear-elastic results are given in separate FIGURES from the nonlinear results of interest. Hysteretic force-deformation behaviors of the bridge frame for linear-elastic and nonlinear responses are given in FIGS. 13 (1300) and 14 (1400), respectively.

As expected, the linear-elastic response stays on the same line and always goes through the origin, with no residual displacement (1300). However, once plastic hinges have formed, the nonlinear behavior of the bridge frame cycles around and results in permanent plastic displacements (1400).

FIG. 14 details the exemplary bridge frame computationally efficient structural analysis algorithm nonlinear force-displacement bridge frame results from the 1989 Loma Prieta earthquake. The strength of the exemplary bridge frame is 1,500 kips (6,670 kN) with all plastic hinges developed, achieved in both loading directions (1400). FIG. 14 also shows that nonlinear behavior occurs in each direction at forces that are much lower than the full strength of the frame. Relative displacement time-history results are provided in FIGS. 15 and 16 for linear-elastic (1500) and nonlinear responses (1600), respectively. Once plastic hinges have formed, the nonlinear behavior is quite different from the linear behavior, having permanent offset and different maximum values.

Base shear results over time are given in FIGS. 17 and 18 for linear (1700) and nonlinear (1800) cases. From FIG. 18 it is clear that the strength of the frame is reached in both directions, while from linear-elastic analysis, the maximum force demand is 8,315 kips (37,000 kN), which is 5.54 times higher than from nonlinear analysis and 5.54 times larger than the force capacity of the frame (1,500 kips (6,670 kN)).

The nonlinear force response is given on the same graph as the linear-elastic force response (1700) in FIG. 17, along with the frame force capacity lines drawn at plus and minus 1,500 kips (6,670 kN). This succinctly illustrates that the large forces from a linear-elastic analysis are not physically possible due to strength limits of the frame associated with column plastic hinging. Maximum displacements from linear-elastic (1500) and nonlinear (1600) analyses are 1.19 ft (0.363 m) and 0.702 ft (0.214 m), respectively. This shows that for the exemplary bridge frame structure, and chosen 1989 Loma Prieta earthquake motion, the displacement demand from NTHA is only 59% of the linear-elastic demand, indicating possible cost savings from the more detailed nonlinear analysis.

Zoomed-in views (from 5 to 15 s) of nonlinear displacement (1900) and force (2000) results show that the ICFM provide the same maximum and time-history values as the stiffness method illustrated by FIGS. 19 and 20, respectively. Advantageously however, as indicated in Table 2, the present ICFM performs at orders of magnitude faster speed than the stiffness method. For the 1989 Loma Prieta earthquake motion discussed in the example, the ICFM was more than 3,000 times faster than the stiffness method. When a different motion from the 2010 Mexicali earthquake was used (Table 2), with five times the number of increments than the original motion, the ICFM was more than 5,000 times faster than the stiffness method. In this case the stiffness method took over 23 minutes while the ICFM took just over a quarter of a second.

In conclusion, a completely novel approach has been developed to assess the nonlinear time-history response of a bridge frame or other structure subjected to seismic loading. The present ICFM has proven to be thousands of times faster than the conventional stiffness method while providing the same maximum results and the same results over time. Identical input models were created based on the example bridge provided and the discussions given in the text. All nonlinear time-history results were the same between the two methods, with the only difference being the time to compute these results; the ICFM was over 3,000 times faster than the stiffness method for the primary ground motion studied and over 5,000 times faster for a second ground motion, which had more increments due to a smaller time step and longer duration.

Such increases in computational speed will result in changes to the way bridge frame structures are designed for seismic loading. Multiple earthquake motions can now be calculated through the bridge frame or other structure, allowing all possible scenarios to be considered by the bridge designer. Using the new ICFM, the average NTHA solution time for the two different earthquake motions was 0.172 s for the example bridge. Taking this as an approximate average for multiple motions, the nonlinear bridge response from 10 different earthquake motions can be assessed in less than two seconds, with maximum results of interest automatically saved for later viewing. Following the same logic, over 300 different nonlinear time-history analyses could be performed in one minute for the 5-span bridge frame example. Using traditional stiffness method (represented by the computer program SAP2000) this same task would take over 67 hours of straight running time.

While, theoretically, the stiffness method or the ICFM could be used to perform NTHA of a bridge frame, due to practical limitations the stiffness method has not been used for everyday seismic bridge design, relegating it to large, high budget bridge projects. The speed, stability and ease of use of the new ICFM allows NTHA to be conducted for seismic design of commonplace bridge frame or other structures. Furthermore, the algorithm has been specifically designed for this purpose with minimal input required. Because it will provide a proper assessment tool to bridge design engineers for seismic demands, the ICFM makes bridge structures safer and, in many cases, significantly reduces bridge construction costs.

For the example bridge frame and chosen earthquake motion, NTHA resulted in 59% of the displacement demand from linear-elastic analysis, indicating over-design and increased costs if the larger displacement demands from linear-elastic analysis are used for seismic design. In other cases it can be the opposite, with NTHA displacement demands considerably larger than from linear-elastic analysis. In this case the bridge will be seismically unsafe if the smaller displacement demands from linear-elastic analysis are targeted in design. While there are various linear-elastic methods that attempt to capture equivalent nonlinear seismic displacement demands of a bridge frame, they are not capable of providing consistent results that only NTHA can give.

Other embodiments of the ICFM algorithm comprise 3-D frame effects, different hysteresis models for column plastic hinges, P-delta effects, soil springs at the base of the columns, interaction between adjacent bridge frames as well as between a bridge frame and the soil behind abutments.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field computationally efficient non-linear structural analysis algorithm mable gate array (FPGA) or other computationally efficient non-linear structural analysis algorithm mable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer computationally efficient nonlinear structural analysis algorithm from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired computationally efficient nonlinear structural analysis algorithm code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for seismic analysis of frame structures comprising:
performing an initial dead load analysis of structure moments and stiffness;
calculating, from Incremental Closed Form Method (ICFM) Equations, incremental time values of acceleration, velocity, displacement and final structure moments;
summing the incremental values to produce a total sum value of all calculated time increment values;
adjusting frame stiffness values are for a next incremental time value calculation;
scaling the calculated time increment values for the time increment to the time of an event; and
repeating the calculating, summing, adjusting and scaling until ICFM calculations of all time increments of ground motion have been completed and summed.

2. The method of claim 1 wherein, R=Cycle factor going to the right of a beam, T=Cycle factor going to the left of a beam, r=Distribution factor for member on the right side of a joint, t=Distribution factor for member on the left side of a joint, c=Distribution factor for column at a joint, AB_{C}=Member moment just to the right of Joint A from a unit moment applied at Joint B for a continuous beam or bridge frame with C number of internal joints, BA_{C}=Member moment just to the left of a Joint B from a unit moment applied at a Joint A for a continuous beam or bridge frame with C number of internal joints, r_{A}·r_{B}=Multiplication of r_{A}, r_{A+1}, . . . through r_{B}, r₂·r₅=Multiplication of r₂, r₃, r₄ and r₅, R_{A}·R_{B}=Multiplication of R_{A}, R_{A+1}, . . . through R_{B}, t_{A}·t_{B}=Multiplication of t_{A}, t_{A+1}, . . . through t_{B}, and T_{A}·T_{B}=Multiplication of T_{A}, T_{A+1}, . . . through T_{B}.

3. The method of claim 2 wherein, A Superstructure Right Moment is defined as
$${AB}_{C} = \frac{{r}_{B} . {r}_{A}}{{( - 2 )}^{A - B} {R}_{B} \cdot {R}_{C}} {T}_{C} \cdot {T}_{A + 1} [ 1 - \frac{{t}_{A + 1}}{4 {T}_{A + 1}} ] .$$

4. The method of claim 2 wherein, a Column Right Moment is defined as
$${AB}_{C} = \frac{{r}_{B} \cdot {r}_{A - 1} {c}_{A}}{{( - 2 )}^{A - B} {R}_{B} \cdot {R}_{C}} {T}_{C} \cdot {T}_{A + 1}$$

5. The method of claim 2 wherein, a Simplified Superstructure Right Moment for a Last Internal Joint is defined as
$${CB}_{C} = \frac{{r}_{B} \cdot {r}_{C}}{{( - 2 )}^{C - B} {R}_{B} \cdot {R}_{C}} .$$

6. The method of claim 2 wherein, a Simplified Column Right moment for a Last Internal Joint is defined as
$${CB}_{C} = \frac{{r}_{B} \cdot {r}_{C - 1} {c}_{c}}{{( - 2 )}^{C - B} {R}_{B} \cdot {R}_{C}} .$$

7. The method of claim 2 wherein, a Superstructure Left Moment is defined as
$${BA}_{C} = \frac{{t}_{A} \cdot {t}_{B}}{{( - 2 )}^{A - B} {T}_{1} \cdot {T}_{A}} {R}_{1} \cdot {R}_{B - 1} [ 1 - \frac{{r}_{B - 1}}{4 {R}_{B - 1}} ]$$

8. The method of claim 2 wherein, a Column left Moment is defined as
$${BA}_{C} = \frac{{t}_{A} \cdot {t}_{B + 1} {c}_{B}}{{( - 2 )}^{A - B} {T}_{1} \cdot {T}_{A}} {R}_{1} \cdot {R}_{B - 1}$$

9. The method of claim 2 wherein, a Simplified Superstructure Left Moment for a First Internal Joint is defined as
$$1 {A}_{C} = \frac{{t}_{1} \cdot {t}_{A}}{{( - 2 )}^{A - 1} {T}_{1} \cdot {T}_{A}}$$

10. The method of claim 2 wherein, A Simplified Column Left Moment For a First Internal Joint is defined as
$$1 {A}_{C} = \frac{{t}_{2} \cdot {t}_{A} {c}_{1}}{{( - 2 )}^{A - 1} {T}_{1} \cdot {T}_{A}}$$

11. The method of claim 1 wherein the method is implemented in a mobile application or mobile device.

12. A computer readable medium having instructions stored thereon to cause a processor in a wireless device to:
perform an initial dead load analysis of structure moments and stiffness;
calculate, from Incremental Closed Form Method (ICFM) Equations, incremental time values of acceleration, velocity, displacement and final structure moments;
sum the incremental values to produce a total sum value of all calculated time increment values;
adjust frame stiffness values are for a next incremental time value calculation;
scale the calculated time increment values for the time increment to the time of an event; and
repeat the calculating, summing, adjusting and scaling until ICFM calculations of all time increments of ground motion have been completed and summed.

13. The computer readable medium of claim 12 wherein, R=Cycle factor going to the right of a beam, T=Cycle factor going to the left of a beam, r=Distribution factor for member on the right side of a joint, t=Distribution factor for member on the left side of a joint, c=Distribution factor for column at a joint, AB_{C}=Member moment just to the right of Joint A from a unit moment applied at Joint B for a continuous beam or bridge frame with C number of internal joints, BA_{C}=Member moment just to the left of a Joint B from a unit moment applied at a Joint A for a continuous beam or bridge frame with C number of internal joints, r_{A}·r_{B}=Multiplication of r_{A}, r_{A+1}, . . . through r_{B}, r₂·r₅=Multiplication of r₂, r₃, r₄ and r₅, R_{A}·R_{B}=Multiplication of R_{A}, R_{A+1}, . . . through R_{B}, t_{A}·t_{B}=Multiplication of t_{A}, t_{A+1}, . . . through t_{B}, and T_{A}·T_{B}=Multiplication of T_{A}, T_{A+1}, . . . through T_{B}.

14. The computer readable medium of claim 13 wherein, A Superstructure Right Moment is defined as
$${AB}_{C} = \frac{{r}_{B} \cdot {r}_{A}}{{( - 2 )}^{A - B} {R}_{B} \cdot {R}_{C}} {T}_{C} \cdot {T}_{A + 1} [ 1 - \frac{{t}_{A + 1}}{4 {T}_{A + 1}} ] .$$

15. The computer readable medium of claim 13 wherein, a Column Right Moment is defined as
$${AB}_{C} = \frac{{r}_{B} \cdot {r}_{A - 1} {c}_{A}}{{( - 2 )}^{A - B} {R}_{B} \cdot {R}_{C}} {T}_{C} \cdot {T}_{A + 1} .$$

16. The computer readable medium of claim 13 wherein, a Simplified Superstructure Right Moment for a Last Internal Joint is defined as
$${CB}_{C} = \frac{{r}_{B} \cdot {r}_{C}}{{( - 2 )}^{C - B} {R}_{B} \cdot {R}_{C}} .$$

17. The computer readable medium of claim 13 wherein, a Simplified Column Right moment for a Last Internal Joint is defined as
$${CB}_{C} = \frac{{r}_{B} \cdot {r}_{C - 1} {c}_{c}}{{( - 2 )}^{C - B} {R}_{B} \cdot {R}_{C}} .$$

18. The computer readable medium of claim 13 wherein, a Superstructure Left Moment is defined as
$${BA}_{C} = \frac{{t}_{A} \cdot {t}_{B}}{{( - 2 )}^{A - B} {T}_{1} \cdot {T}_{A}} {R}_{1} \cdot {R}_{B - 1} [ 1 - \frac{{r}_{B - 1}}{4 {R}_{B - 1}} ]$$

19. The computer readable medium of claim 13 wherein, a Column left Moment is defined as
$${BA}_{C} = \frac{{t}_{A} \cdot {t}_{B + 1} {c}_{B}}{{( - 2 )}^{A - B} {T}_{1} \cdot {T}_{A}} {R}_{1} \cdot {R}_{B - 1}$$

20. The computer readable medium of claim 13 wherein, a Simplified Superstructure Left Moment for a First Internal Joint is defined as
$$1 {A}_{C} = \frac{{t}_{1} \cdot {t}_{A}}{{( - 2 )}^{A - 1} {T}_{1} \cdot {T}_{A}}$$

21. The computer readable medium of claim 13 wherein, A Simplified Column Left Moment For a First Internal Joint is defined as
$$1 {A}_{C} = \frac{{t}_{2} \cdot {t}_{A} {c}_{1}}{{( - 2 )}^{A - 1} {T}_{1} \cdot {T}_{A}}$$
